(19) United States
(12) Patent Application Publication
(10) Pub. No.: US 2016/0105513 A1
(43) Pub. Date: Apr. 14, 2016

(54) Vehicle Gateway Module Having Cellular Data Network Connectivity

(71) Applicant: Lear Corporation, Southfield, MI (US)

(72) Inventors: Jason G. Bauman, Birmingham, MI (US); Gerald L. Grabowski, Brownstown, MI (US)

(21) Appl. No.: 14/513,751

(22) Filed: Oct. 14, 2014

(51) Int. Cl. H04L 29/08; H04W 4/00; H04L 12/24

(52) U.S. Cl. CPC H04L 67/12; H04L 41/0803; H04W 4/008; H04W 88/16

(57) ABSTRACT

A vehicle gateway module is configured to communicate over vehicle networks connected to the gateway module with vehicle devices connected to the vehicle networks. The gateway module has a cellular data link which provides a direct connection between the gateway module and the Internet whereby communication between a vehicle device connected to a vehicle network connected to the gateway module and the Internet is enabled via the gateway module and the cellular data link.

### TECHNICAL FIELD

The present invention relates to vehicle gateway modules.

### BACKGROUND

A vehicle gateway module enables communication between vehicle devices operating on vehicle networks.

### SUMMARY

An object of the present invention includes a vehicle gateway module having cellular data network connectivity.

Another object of the present invention includes a vehicle gateway module configured to use a cellular data network for Internet connectivity.

Another object of the present invention includes a vehicle gateway module having cellular data network connectivity to enable a remote provider to provide re-flash software to the gateway module via a cellular data network for receipt by one or more vehicle devices operating on one or more vehicle networks in communication with the gateway module.

Another object of the present invention includes a vehicle gateway module having cellular data network connectivity to enable a remote connection to communicate via a cellular data network with one or more vehicle devices operating on one or more vehicle networks in communication with the gateway module.

In carrying out at least one of the above and other objects, the present invention provides a system for a vehicle. The system includes a gateway module configured to communicate over vehicle networks connected to the gateway module with vehicle devices connected to the vehicle networks. The gateway module has a cellular data link which provides a direct connection between the gateway module and the Internet whereby communication between a vehicle device connected to a vehicle network connected to the gateway module and the Internet is enabled via the gateway module and the cellular data link.

In an embodiment, the cellular data link is one of a 3G data link and a 4G data link.

In an embodiment, the gateway module further includes a first wireless link in which the first wireless link is one of a WiFi™ wireless link and a Bluetooth™ wireless link. In an embodiment, the gateway module further includes a second wireless link in which the second wireless link is the other one of a WiFi™ wireless link and a Bluetooth™ wireless link.

Further, in carrying out at least one of the above and other objects, the present invention provides a method for a vehicle. The method includes providing a gateway module configured to communicate over vehicle networks connected to the gateway module with vehicle devices connected to the vehicle networks. The method further includes communicating, via the gateway module and a cellular data link of the gateway module in which the cellular data link provides a direct connection between the gateway module and the Internet, between a vehicle device connected to a vehicle network connected to the gateway module and the Internet.

In an embodiment, the method further includes receiving by the gateway module, via the cellular data link, re-flash software for receipt by a recipient vehicle device connected to a vehicle network connected to the gateway module.

In an embodiment, the method further includes controlling by a remote entity connected to the Internet, via the cellular data link and the gateway module, a targeted vehicle device connected to a vehicle network connected to the gateway module.

In an embodiment, the method further includes receiving by a remote entity connected to the Internet, via the cellular data link and the gateway module, diagnostic information from a targeted vehicle device connected to a vehicle network connected to the gateway module.

Also, in carrying out at least one of the above and other objects, the present invention provides a method for a vehicle. The method includes providing a gateway module configured to communicate over vehicle networks connected to the gateway module with vehicle devices connected to the vehicle networks and having a cellular data link which provides a direct connection between the gateway module and the Internet. The method further includes downloading from a remote entity connected to the Internet, via the cellular data link, re-flash software to a recipient vehicle device connected to a vehicle network connected to the gateway module.

In an embodiment, the downloading includes communicating from the remote entity, via the cellular data link, the re-flash software to the gateway module, and subsequently transferring by the gateway module the re-flash software to the recipient vehicle device over the vehicle network connected to the recipient vehicle device.

### BRIEF DESCRIPTION OF THE DRAWINGS

FIG. 1 illustrates a block diagram of a vehicle gateway module in accordance with an embodiment of the present invention; and

FIG. 2 illustrates a block diagram of an environment including the gateway module in communication with vehicle networks and a cellular data network in accordance with an embodiment of the present invention.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

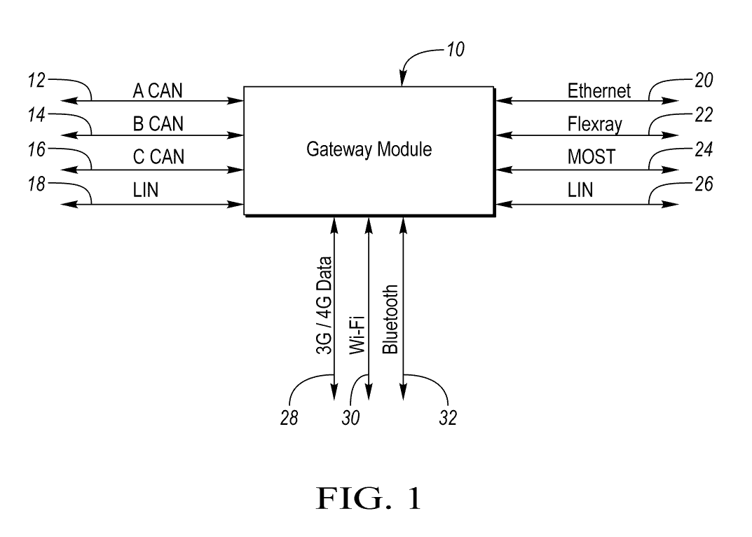

Referring now to FIG. 1, a vehicle gateway module 10 in accordance with an embodiment of the present invention is shown. Gateway module 10 is mountable within a vehicle and is configured to enable communication between and with vehicle devices operating on one or more vehicle networks. Such vehicle devices include controllers configured to control associated vehicle components and sensors configured to monitor associated vehicle components. A set of vehicle devices may operate on a vehicle network. Gateway module 10 and the set of vehicle devices are connected to one another through the vehicle network. The vehicle devices use the vehicle network to exchange information with one another and/or gateway module 10. The exchanged information may be in regards to the control and/or monitoring of the vehicle components associated with the vehicle devices.

Similarly, a second set of vehicle devices may operate on a second vehicle network, a third set of vehicle devices may operate on a third vehicle network, etc. Gateway module 10 and the second and third sets of vehicle devices are connected to one another through the second and third vehicle networks, respectively. In each case, vehicle devices operating on a vehicle network use that network to exchange information with one another and/or gateway module 10.

Gateway module 10 enables communication between vehicle devices operating on different vehicle networks. Gateway module 10 enables such communication in either case of the vehicle networks being of the same type or of different types. Vehicle networks of the same type use the same communication protocol whereas vehicle networks of different types use different communication protocols from one another.

For example, as shown in FIG. 1, gateway module 10 is connected to a plurality of vehicle networks 12, 14, 16, 18, 20, 22, 24, and 26. The vehicle networks include a first Controller Area Network (CAN) 12, a second CAN 14, a third CAN 16, a first Local Interconnect Network (LIN) 18, an Ethernet network 20, a F1exRay™ network 22, a Media Oriented Systems Transport (MOST) network 24, and a second LIN 26.

Each vehicle network may connect with none or one or more vehicle devices operating on the network. For instance, first CAN 12 may be a vehicle powertrain CAN bus including engine, transmission, and brake controllers as well as other directly related sensors and actuators. Second CAN 14 may be a comfort or body CAN bus used to run comfort systems such as power windows, seat memory, tire pressure, etc. First LIN 18 may be an application LIN bus for applications such as an air conditioner or wiper control. MOST network 24 may be an infotainment MOST bus.

Vehicle networks 12, 14, 16, 18, 20, 22, 24, and 26 are either of the same type and use the same communication protocol or of different types and use different communication protocols. For instance, CANs 12, 14, and 16 are of the same type and use the same communication protocol. Likewise, LINs 18 and 26 are of the same type and use the same communication protocol. However, the communication protocol used by CANs 12, 14, and 16 is different than the communication protocol used by LINSs 18 and 26. Each of the other networks 20, 22, and 24 use their own communication protocol different than the communication protocols of any of the other networks. As such, gateway module 10 is configured to function as a translator in enabling communication between vehicle devices operating on vehicle networks employing different communication protocols. In general, gateway module 10 manages network traffic on vehicle networks connected to the gateway module.

Gateway module 10 further includes an embedded cellular data link 28. Cellular data link 28 provides gateway module 10 with cellular data network connectivity. Cellular data link 28 such as a 3G or 4G data link is a direct connection between gateway module 10 and an external Internet access node of an Internet access provider. The Internet access node is in communication with the Internet. As such, gateway module 10 is configured to use a cellular data network for Internet connectivity and such connectivity is “always on.”

Gateway module 10 may further include an embedded wireless link 30. Wireless link 30 provides gateway module 10 with short range wireless connectivity. For example, wireless link 30 is a WiFi™ link. Alternatively or additionally, gateway module 10 may further include a second embedded wireless link 32. Second wireless link 32 also provides gateway module 10 with short range wireless connectivity. For example, second wireless link 32 is a Bluetooth™ wireless link.

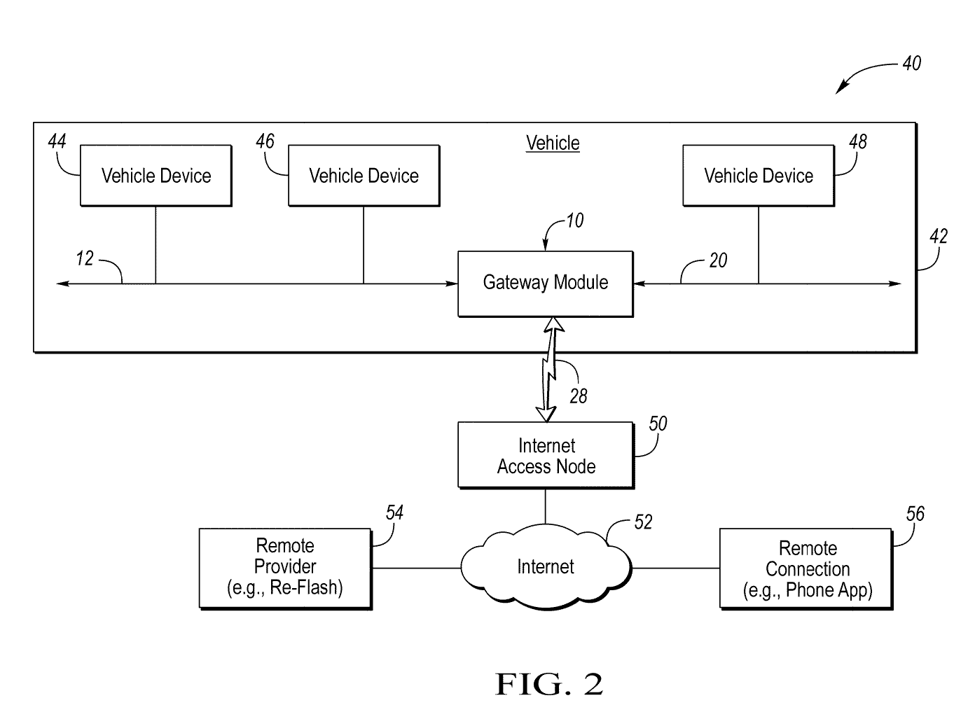

Referring now to FIG. 2, with continual reference to FIG. 1, a block diagram of an environment 40 including gateway module 10 in communication with vehicle networks and a cellular data network in accordance with an embodiment of the present invention is shown. As shown in FIG. 2, gateway module 10 is a component of a vehicle 42. For simplicity, gateway module 10 is shown in FIG. 2 as being connected just to CAN 12 and Ethernet network 20. CAN 12 and Ethernet network 20 are of different types and employ different communication protocols as described above. A first vehicle device 44 and a second vehicle device 46 operate on CAN 12. A third vehicle device 48 operates on Ethernet network 20. As described above, gateway module 10 enables communication between devices 44 and 46 on CAN 12 and device 48 on Ethernet network 20 with one another and/or gateway module 10.

Cellular data link 28 provides a direct cellular connection between gateway module 10 and an Internet access node 50 in communication with the Internet 52. As such, communication between gateway module 10 and the Internet 52 can take place via cellular data link 28. As described, gateway module 10 is in communication with devices 44 and 46 on CAN 12 and is in communication with device 48 on Ethernet network 20. Accordingly, communication between any of devices 44, 46, and 48 and the Internet 52 can take place via gateway module 10 and cellular data link 28.

For instance, in environment 40 a remote provider 54 is in communication with the Internet 52. Remote provider 54 and gateway module 10 can thereby communicate with one another via cellular data link 28. Likewise, when authorized, remote provider 54 can communicate with any of devices 44, 46, and 48 via gateway module 10 and cellular data link 28.

In an embodiment, gateway module 10 receives re-flash software from remote provider 54 via cellular data link 28. The re-flash software is for receipt by one or more of devices 44, 46, and 48. When authorized, the re-flash software is communicated from remote provider 54 to recipient devices 44, 46, and/or 48 over the corresponding vehicle networks 12 and/or 20 via gateway module 10 and cellular data link 28. In this manner, the re-flash software is directly downloaded “over the air” to the recipient devices 44, 46, and/or 48. Alternatively, the re-flash software is downloaded from remote provider 54 to gateway module 10 and the gateway module re-flashes the recipient devices 44, 46, and/or 48 when appropriate (e.g., the vehicle is off, vehicle network asleep, etc.).

As another example, in environment 40 a remote connection 56 (e.g., a phone app) is in communication with the Internet 52. Remote connection 56 and gateway module 10 can thereby communicate with one another via cellular data link 28. Correspondingly, when authorized, remote connection 56 can communicate with any of devices 44, 46, and 48 via gateway module 10 and cellular data link 28.

In an embodiment, remote connection 56 communicates with devices 44, 46, and/or 48 over corresponding vehicle networks 12 and/or 20 via cellular data link 28 and gateway module 10 to control devices 44, 46, and/or 48. For instance, remote connection 56 controls a vehicle device remotely via cellular data link 28 for functions such as remote start, vehicle unlock, setting temperature, etc.

In an embodiment, remote connection 56 communicates with devices 44, 46, and/or 48 over corresponding vehicle networks 12 and/or 20 via cellular data link 28 and gateway module 10 to monitor the status of devices 44, 46, and/or 48. For instance, remote connection 56 obtains vehicle function alerts/status from devices 44, 46, and/or 48. Such functions include alarm activation, location, fault conditions, etc.

Remote provider 54 and remote connection 56 are examples of remote entities connected to Internet 52 which can thereby communicate with gateway module 10 via cellular data link 28. Of course, there are other types of remote entities which can communicate with gateway module 10 via cellular data link 28. By being able to communicate with gateway module 10 via cellular data link 28, a remote entity can thereby communicate (when authorized by gateway module 10) with vehicle devices connected to vehicle networks connected to gateway module 10.

In an embodiment, a remote entity can send a request to the vehicle owner to inform the owner that a re-flash is to occur and to seek the owner's consent to perform the re-flash. That request can come via gateway module 10 or via a direct 3G/4G communication from the remote entity to the owner's mobile device. The remote entity can likewise inform the vehicle owner via the mobile device about the status of completion of the re-flash.

As described, cellular data link 28 of gateway module 10 is an “always on” external data connection. As a result, gateway module 10 provides always on access to vehicle diagnostic information of vehicle networks connected to the gateway module. Such vehicle diagnostic information and vehicle data can be uploaded from gateway module 10 to a remote provider 54 and/or a remote connection 56 via cellular data link 28.

In general, the always on external data connection provided by cellular data link 28 supports vehicle control, vehicle status, live diagnosis, and re-flashing of vehicle devices operating on vehicle networks connected to gateway module 10. As gateway module 10 is a central hub the gateway module 10 has access to the vehicle networks connected to the gateway module and can thereby manage cyber security, diagnostics, and over-the-air re-flashing. Therefore, it is advantageous that gateway module 10 includes cellular data link 28 which provides a wireless connection to the outside world to support direct Internet connectivity.

Referring now back to FIG. 1, with continual reference to FIG. 2, gateway module 10 may further include a WiFi™ wireless link 30 and/or a Bluetooth™ wireless link 32. Communications between gateway module 10 and the non-remote provider may take place over either wireless link 30 or 32. That is, in this case, gateway module 10 and the non-remote provider are in direct communication via wireless link 30 or 32. Likewise, communications between gateway module 10 and a non-remote connection may take place over either wireless link 30 or 32. As such, in this case, gateway module 10 and the non-remote connection are in direct communication via wireless link 30 or 32. As used herein, a remote entity is an entity (i.e., provider, connection) remotely located far enough away from gateway module 10 that communication with gateway module 10 can only take place via cellular data link 28 and not via wireless links 30 or 32.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A system for a vehicle comprising:
a gateway module configured to communicate over vehicle networks connected to the gateway module with vehicle devices connected to the vehicle networks, the gateway module having a cellular data link which provides a direct connection between the gateway module and the Internet whereby communication between a vehicle device connected to a vehicle network connected to the gateway module and the Internet is enabled via the gateway module and the cellular data link.

2. The system of claim 1 wherein:
the gateway module is further configured to receive re-flash software via the cellular data link from a remote entity connected to the Internet for receipt by a recipient vehicle device connected to a vehicle network connected to the gateway module.

3. The system of claim 1 wherein:
the gateway module is further configured to exchange communication communicated via the cellular data link between a remote entity connected to the Internet and a vehicle device connected to a vehicle network connected to the gateway module.

4. The system of claim 1 wherein:
the vehicle networks are respectively one of a Controller Area Network (CAN), a Local Interconnect Network (LIN), an Ethernet network, a F1exRay™ network, and a Media Oriented Systems Transport (MOST) network.

5. The system of claim 1 wherein:
the vehicle networks use different communication protocols from one another.

6. The system of claim 1 wherein:
the gateway module is further configured to enable communication between vehicle devices connected to vehicle networks connected to the gateway module in which the vehicle networks use different communication protocols from one another.

7. The system of claim 1 wherein:
the cellular data link is one of a 3G data link and a 4G data link.

8. The system of claim 1 wherein:
the gateway module further includes a first wireless link, the first wireless link being one of a WiFi™ wireless link and a Bluetooth™ wireless link.

9. The system of claim 8 wherein:
the gateway module further includes a second wireless link, the second wireless link being the other one of a WiFi™ wireless link and a Bluetooth™ wireless link.

10. A method for a vehicle comprising:
providing a gateway module configured to communicate over vehicle networks connected to the gateway module with vehicle devices connected to the vehicle networks; and
communicating, via the gateway module and a cellular data link of the gateway module in which the cellular data link provides a direct connection between the gateway module and the Internet, between a vehicle device connected to a vehicle network connected to the gateway module and the Internet.

11. The method of claim 10 further comprising:
receiving by the gateway module, via the cellular data link, re-flash software for receipt by a recipient vehicle device connected to a vehicle network connected to the gateway module.

12. The method of claim 11 further comprising:
transferring by the gateway module the re-flash software to the recipient vehicle device over the vehicle network connected to the recipient vehicle device.

13. The method of claim 10 further comprising:
transferring by a remote entity connected to the Internet, via the cellular data link and the gateway module, re-flash software to a recipient vehicle device connected to a vehicle network connected to the gateway module.

14. The method of claim 10 further comprising:
communicating, via the cellular data link and the gateway module, between a vehicle device connected to a vehicle network connected to the gateway module and a remote entity connected to the Internet.

15. The method of claim 10 further comprising:
controlling by a remote entity connected to the Internet, via the cellular data link and the gateway module, a targeted vehicle device connected to a vehicle network connected to the gateway module.

16. The method of claim 10 further comprising:
receiving by a remote entity connected to the Internet, via the cellular data link and the gateway module, diagnostic information from a targeted vehicle device connected to a vehicle network connected to the gateway module.

17. A method for a vehicle comprising:
providing a gateway module configured to communicate over vehicle networks connected to the gateway module with vehicle devices connected to the vehicle networks and having a cellular data link which provides a direct connection between the gateway module and the Internet; and
downloading from a remote entity connected to the Internet, via the cellular data link, re-flash software to a recipient vehicle device connected to a vehicle network connected to the gateway module.

18. The method of claim 17 wherein:
the downloading includes communicating from the remote entity, via the cellular data link, the re-flash software to the gateway module, and subsequently transferring by the gateway module the re-flash software to the recipient vehicle device over the vehicle network connected to the recipient vehicle device.

19. The method of claim 17 wherein:
the vehicle devices include vehicle controllers and vehicle sensors.

20. The method of claim 17 wherein:
the cellular data link is one of a 3G data link and a 4G data link.
